(19) United States
(12) Patent Application Publication
(10) Pub. No.: US 2001/0023413 A1
(43) Pub. Date: Sep. 20, 2001

(54) Eyeglass frame synthesizing system and eyeglass frame selling method

(76) Inventors: Yasufumi Fukuma, Tokyo (JP); Takeyuki Kato, Tokyo (JP); Narumi Machida, Tokyo (JP)

Correspondence Address: CHAPMAN AND CUTLER, 111 WEST MONROE STREET, CHICAGO, IL, 60603, US

(21) Appl. No.: 09/812,196

(22) Filed: Mar. 19, 2001

(30) Foreign Application Priority Data
Mar. 17, 2000 (JP) 2000-75211
Feb. 21, 2001 (JP) 2001-44944

(51) Int. Cl. G06F 17/60

(52) U.S. Cl. 705/27; 348/610; 351/177; 351/41; 340/5.83

(57) ABSTRACT

An eyeglass synthesizing system which a customer can try wearing the eyeglass frame at his/her home is provided. A home page which an optician 7 prepares is accessed through Internet using a web browser of a personal computer, and an eyeglass frame 14 provided at the home page is selected and the selected eyeglass frame 14 is synthesized with a facial picture 15. Accordingly, the synthesized picture is displayed on the monitor screen 2A.

### BACKGROUND OF THE INVENTION

1. Field of the Invention

The present invention relates to an eyeglass frame synthesizing system which a customer can try wearing the eyeglass frame at home.

2. Description of the Prior Art

Conventionally, an optician allows a customer who visits the optician to try wearing an eyeglass frame and to select the favorite eyeglass frame, looking at his/her own face wearing the eyeglass frame in a mirror, and sells to the customer the eyeglasses in which lenses are inserted to the eyeglass frame.

However, in the conventional selling system of the optician, it is inconvenient for the customer who has no time because the customer cannot try wearing the eyeglass frame unless the customer visits the optician.

Today, Internet era, a home page is prepared by the optician and is displayed on the monitor screen of a personal computer at home, an eyeglass frame being selected on the monitor screen and synthesized with the customer's facial picture. In this manner, since a person having a personal computer can try wearing the eyeglass frame at home, it is convenient to save the person trouble of visiting the optician personally. In addition, it is preferable that the person can select the eyeglass frame until he/she finds the favorite eyeglass frame.

Also, the trend of purchaser with respect to the eyeglass frame can be known by understanding what kind of the eyeglass frame is selected. Further, the popularity of new eyeglass frame can be known.

Also, if the sex and age are inputted at the selected screen when the customer try wearing the eyeglass frame, the trend of favorite frame can be known by taking statistics by sex or age, a thereby the market research can be accomplished.

### SUMMARY OF THE INVENTION

The present invention is made considering the above conditions, and the object of the present invention is to provide an eyeglass frame synthesizing system which a customer can try wearing the eyeglass frame at home.

The eyeglass frame synthesizing system according to a first aspect of the present invention accesses a home page which an optician prepares through Internet using a web browser, selects an eyeglass frame provided at said home page, synthesizes the selected eyeglass frame with the facial picture, and displays the synthesized picture on the monitor screen.

The eyeglass frame synthesizing system according to a second aspect of the present invention presents an eyeglass frame selection screen for displaying a picture in which the facial picture is Synthesized with the selected eyeglass frame on the monitor screen, in a home page prepared by an optician and accessible through Internet using a web browser, and at the same time, downloads a picture synthesizing program for synthesizing said facial picture with the selected eyeglass frame, and displays the synthesized picture on said monitor screen, on the basis of said home page.

According to the first or second aspect of the present invention, it is convenient that the customer can select the eyeglass frame on the monitor screen without visiting the optician personally.

The eyeglass frame synthesizing system according to a third aspect of the present invention stores an image of the face of the customer who visits said optician in a recording medium using a television camera provided at the shop of said optician or television cameras provided at the predetermined places, lets the customer select the eyeglass frame provided at said home page on said monitor screen, and at the same time, reads said facial picture stored in said recording medium to synthesize said facial picture with said eyeglass frame.

According to the third aspect of the present invention, since the customer's face is photographed using the television camera provided at the optician's shop, it is easy to fit the photographing magnification of the eyeglass frame with that of the customer's face, and it is convenient for the customer to synthesize the picture at home without adjusting the magnification. The television camera may be provided at the predetermined places such as the station yard, the shopping center, and the convenient store as well as the optician.

In the eyeglass frame synthesizing system according to a fourth aspect of the present invention, a resource of information on said eyeglass frame is stored in an eyeglass frame manufacturing maker, and said eyeglass frame can be selected by linking to said resource through said optician's shop.

According to the further aspect of the present invention, the resource of information on eyeglass frame can be provided even though the optician does not keep the eyeglass frame database.

The composition that the eyeglass frames and the facial pictures of model are displayed at said home page, and said eyeglass frame and said facial picture of model are selected and synthesized may be employed.

In this manner, the favorite eyeglass frame can be selected by synthesizing the models face with the eyeglass frame, instead of the customer's face.

As described in the second aspect of the present invention, if the picture synthesizing program of said eyeglass frame with said facial picture is stored in the server of said optician or said eyeglass frame manufacturing maker and is downloaded to said personal computer, it is convenient for the customer to obtain freely the picture synthesizing program because the person can download the picture synthesizing program to the personal computer to synthesize the picture.

Particularly, in case where the customer who has visited the optician and ordered the eyeglass lens orders the eyeglass frame, since the frame data of eyeglass frame as well as the customer's facial picture are stored in the optician and the prescription value of eyeglass lens is also stored in the optician, the mismatching of the eyeglass frame and the facial picture can be prevented when the customer uses the picture synthesizing program delivered from the same optician. Accordingly, in case where the customer orders the eyeglass frame again, the customer can select and order the favorite eyeglass frame without visiting the optician personally.

In the eyeglass frame synthesizing system according to a fifth aspect of the present invention, said facial picture is photographed by the customer, and in order to adjust the photographing magnification, the picture synthesizing program has an operating means for specifying two points on said monitor screen, and at the same time, lets the customer input the distance between the two points to operate the magnification on the basis of the two points specified on the screen and the inputted distance between the two points.

According to the fifth aspect of the present invention, since the picture photographed by the customer is synthesized with the selected eyeglass frame while adjusting the magnification, the picture can be synthesized without informing the optician of the customer's face.

A hairstyle selection screen is provided at sad home page, and the picture synthesizing program may synthesize the selected hairstyle.

In this manner, since the facial picture having different hairstyle is synthesized with the eyeglass frame, it is judged multilaterally whether the selected eyeglass frame fits the person or not.

Also, a background selection screen is provided at said home page, and the picture synthesizing program may synthesize the selected background.

Then, since the background can be selected, it is judged much multilaterally whether the elected eyeglass frame fits the person or not.

The eyeglass frame synthesizing system according to a sixth and a seventh aspects of the present invention uploads the facial picture of the person who accesses said home page to synthesize the persons facial picture with the selected eyeglass frame in the server side of the optician, and presents the synthesized picture on said monitor screen.

According to the sixth and seventh aspects of the present invention, since the picture is synthesized in the server side, the person can look at the facial picture wearing the selected eyeglass frame on the monitor screen without the picture synthesizing program.

In the eyeglass frame synthesizing system according an eighth aspect of the present invention, when the home page of said optician is accessed, the system asks if select the synthesis of the eyeglass frame and the facial picture, and at the same time, if agree that the picture is synthesized in the server side of said optician, and after at least identifier, and password are inputted, the system uploads said facial picture to synthesize the picture in said server side, authenticates the person himself/herself by allowing the person to input said password, and displays the synthesized picture on said monitor screen by the screen movement.

According to the eighth aspect of the present invention, since at least address and name are inputted, the picture synthesis is performed in the server side of the optician and the synthesized picture is displayed on the monitor screen, the optician side can surly grasp the preliminary customer group, and further, can systematically grasp the customer's favorite eyeglass frame. Also, it is convenient to save the customer trouble of synthesizing the picture. In addition, the customer's (personal) secret can be kept.

The eyeglass frame synthesizing system according to a ninth aspect of the present invention systematically grasps the favorite eyeglass frame of the customer in consideration of the relationship between the selected eyeglass frame and a personal information which is inputted when said eyeglass frame is selected to synthesize the picture and display the synthesized picture on the monitor screen.

According to the ninth aspect of the present invention, the customer can input personal information such as sex and age on the eyeglass frame selection screen when the customer try wearing the eyeglass frame, the trend of favorite frame can be known by taking statistics by sex or age, and thereby, the market research can be accomplished.

The eyeglass frame synthesizing system according to a tenth aspect of the present invention transmits the facial picture to a personal computer, a portable telephone, or PHS by way of inputting the e-mail address at the optician's shop.

According to the tenth aspect of the present invention, since the personal mail address is stored in the customer's server, the system can be used as the information source for sending direct mail,

The eyeglass frame synthesizing system according to an eleventh aspect of the present invention counts the number that the home page is accessed by means of a counter.

According to the eleventh aspect of the present invention, since the number that the home page is accessed is counted by means of the counter, the optician can grasp the person accessing the home page as the preliminary customer group, and particularly, it is preferable to grasp roughly the number of preliminary customer group.

The eyeglass frame synthesizing system according to a twelfth aspect of the present invention displays the frame selection screen of the popular frame at said home page.

In the method for selling eyeglasses according to the thirteenth aspect of the present invention, the method for selling eyeglasses constructs a means having a database for storing data on eyeglass lens and eyeglass frame necessary for making the eyeglasses of the customer who has visited an optician to prepare the eyeglasses, a database for storing a facial picture of the customer who has visited the optician, a database for storing an information on eyeglass frame on various kinds of the eyeglass frame, a web server for providing a home page of the optician on the monitor screen of personal computer, and a picture synthesizing program for synthesizing the eyeglass frame with the facial picture and displaying the synthesized picture, the method comprises the step of selecting the eyeglass frame on said home page, uploading or downloading said picture synthesizing program to display the synthesized picture on the monitor screen, and selling the eyeglasses on the monitor screen according to the order of eyeglass frame.

According to the thirteenth aspect of the present invention, in case where the customer who has visited the optician once and ordered the eyeglass lens orders the eyeglass frame, sine the frame data of the eyeglass frame as well as the customer's facial picture are stored in the optician and the prescription value of the eyeglass lens is also stored in the optician, the mismatching of the eyeglass frame and the facial picture can be prevented when the customer uses the picture synthesizing program delivered from the same optician. Accordingly, in case where the customer orders the eyeglasses again, the customer can select and order the favorite eyeglass frame without visiting the optician personally.

### BRIEF DESCRIPTION OF THE ATTACHED DRAWINGS

FIG. 1 is a diagram showing concept of an eyeglass frame synthesizing system relating to the present invention.

FIG. 2 illustrates the displaying state of the monitor screen of the personal computer relating to the present invention, FIG. 2(a) shows the screen for displaying the wearing corner of eyeglass frame, FIG. 2(b) shows the state that a plurality of eyeglass frames are displayed, FIG. 2(c) shows the state that facial picture input to the personal computer is displayed, and FIG, 2(d) shows the monitor screen on which the selected facial picture is displayed.

FIG. 3 shows the eyeglass frame and the facial picture of a model displayed on the monitor screen of personal computer accessing the home page of the optician.

FIG. 4 is a flow chart for illustrating the picture synthesizing step relating to the second embodiment of the picture synthesizing system according to the present invention,

FIG. 5 illustrates another embodiment of the picture synthesizing system according to the present invention.

FIG. 6 shows the composition of CCD camera for photographing the three-dimensional facial picture.

FIG. 7 shows an example of the method of photographing the eyeglass frame which the person wears, FIG. 7(a) shows the state that the folded eyeglass frame is laid on a section paper, and FIG. 7(b) shows the state that the unfolded eyeglass frame is laid on the section paper.

### DESCRIPTION OF THE PREFERRED EMBODIMENT

The embodiments of the present invention will be explained with reference to the accompanying drawings.

### First Embodiment

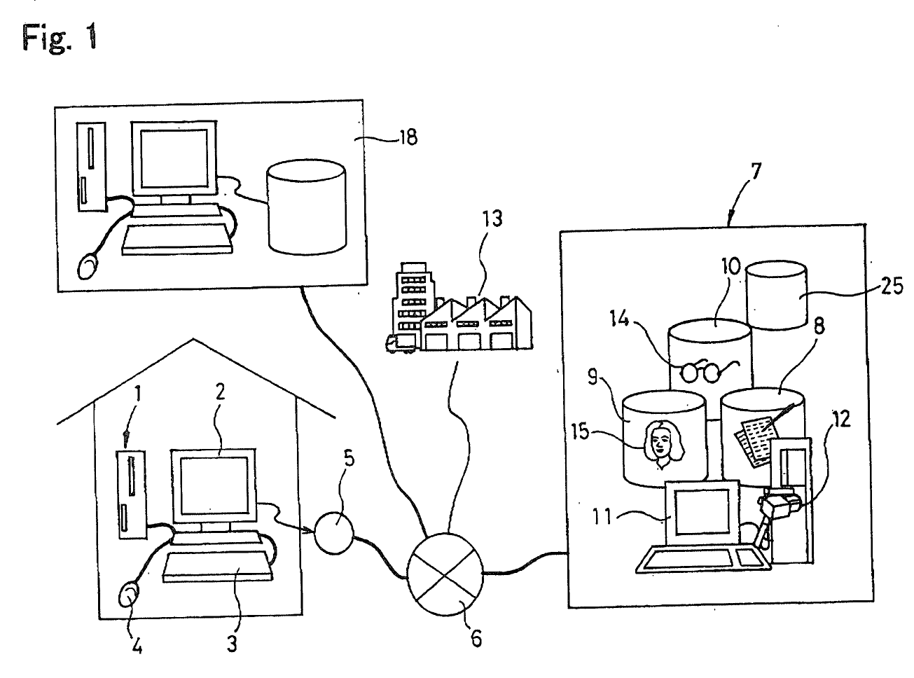

In FIG. 1, 1 is a personal computer which an individual possesses, 2 is a monitor, 3 is a keyboard, and 4 is a mouse. The personal computer 1 is connected to the Internet 6 through a provider 5.

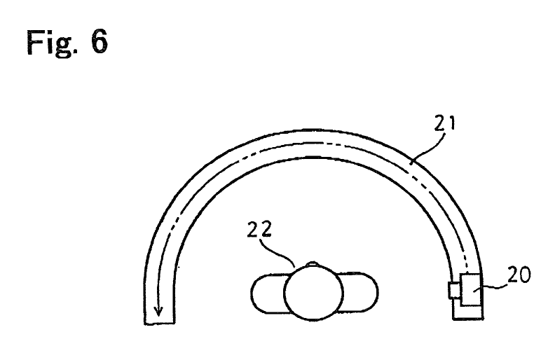

Also, 7 is an optician. The optician 7 is provided with a customer managing database server 8, a facial picture information storing database server 9, an information on eyeglass frame storing database server 10, a web server 11, and a television camera 12. The respective servers 8-11 are connected by LAN, and the television camera 12 is connected to the facial picture information storing database server 9. In addition, as shown in FIG. 6, the CCD camera 20 is rotatably formed in a semicircular groove 21. The CCD camera 20 photographs the customer's face 22, rotating 180 degrees around on the customer's face 22. Thus, if the three-dimensional facial picture is stored in the database server 9, in manufacturing the eyeglass frame, it can be used as a fitting data when the customer wears the eyeglass frame.

The degree of eyeglass lens and the distance between the pupils (PD value) are stored in the customer managing database server 8, and the fitting data (the height of nose, the length of temple, the width of temple, etc.) of eyeglass frame with respect to the customer's face is stored in a fitting database 25.

The web server 9 is connected to the Internet 6. The optician 7 is provided with the information on eyeglass frame through the Internet 6 from the eyeglass frame manufacturing maker 13, and the information on eyeglass frame is successively stored in the information on eyeglass frame storing database server 10 of the optician 7.

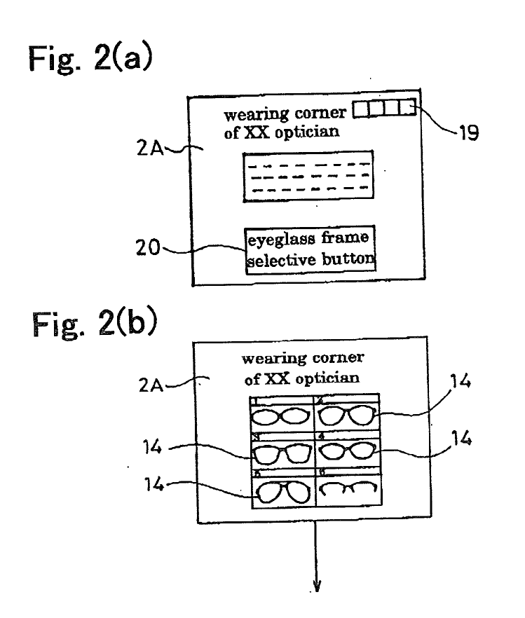

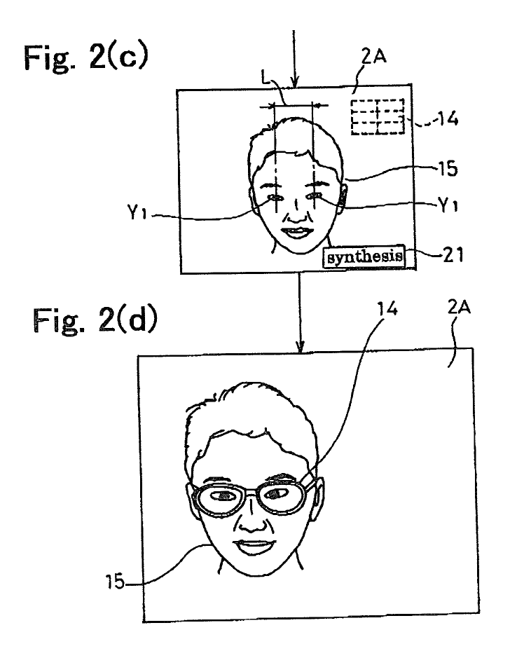

Since the optician 7 prepares the home page, as shown in FIG. 2(a), the eyeglass face wearing corner at the home page of “XX optician” is displayed on the screen 2A of the monitor 2 when a person accesses the home page of the optician 7 and selects the eyeglass frame wearing corner using the web browser of the personal computer 1. A counter 19 is displayed on the monitor screen 2A shown in FIG. 2(a). The counter 19 is counted up when a person selects “wearing corner of the XX optician”. When a screen selecting button 20 for displaying the selected screen of the eyeglass frame 14 is clicked by the mouse 4 and the like, the screen is moved and a plurality of eyeglass frames 14 are splayed on the monitor screen 2A as shown in FIG. 2(b).

The composition that the screen for inputting material, shape, size, and maker name, etc. of the eyeglass frame is displayed on the screen before directly displaying the eyeglass frame 14 on the monitor screen 2A, and then, after the material, the shape, the size, the frame color, and maker name etc. are inputted, the screen is moved to the selection screen of the eyeglass frame 14, may be employed.

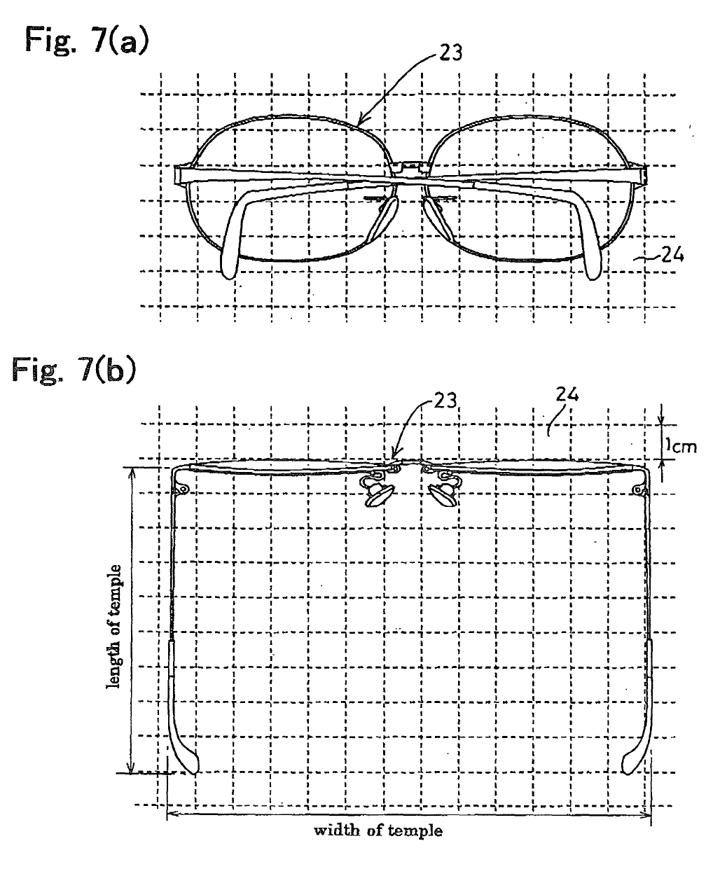

In addition, when a customer orders the eyeglass frame 14, the fitting data (the height of nose, the length of temple, the width of temple) of his/her face with respect to the eyeglass frame 14 may be inputted. In this case, as shown in FIGS. 7(a) and 7(b), the customer lays the eyeglass frame 23 which he/she is wearing on a section paper 24, and photographs the picture of eyeglass frame using an his/her own digital camera (not shown) substantially at a position just above the eyeglass frame, and transmits it to the optician 7 as the picture data, and allows it to be stored in the database 25 as the fitting data. In this manner, the fitting data can be further utilized.

Namely, since the picture of the eyeglass frame 23 laid on the section paper is photographed, the width and length of temple can be judged as the actual size by looking at the scale of the section paper.

On the monitor screen 2A, whether the picture synthesizing program for synthesizing the eyeglass frame with the facial picture is needed or not is inquired, and in case where the picture synthesizing program is needed, the program is downloaded,

Also, the eyeglass frame color may be inputted on the other screen. In addition, when the customer wants to find the eyeglass frames having different color among the selected eyeglass frames, whether the eyeglass frames having different color exists or not way be searched and displayed.

The customer inputs the his/her own facial picture, displays the facial picture 15 on the monitor screen 2A as shown in the eyeglass frame synthesizing system of FIG. 2(c), species the two points Y1 and Y1 on the screen, and inputs the actual distance between the two points Y1 and Y1 through the keyboard 3. Then, when the customer selects the eyeglass frame 14 and clicks a synthesizing button 21 by the mouse 4, the photographing magnification of the facial picture with respect to the eyeglass frame 14 is adjusted by an operating means, the facial picture 15 wearing the selected eyeglass frame 14 is synthesized and displayed on the monitor screen 2A as shown in FIG. 2(d).

In the embodiment of the present invention, a customer or a person synthesizes the selected eyeglass frame 14 with the facial picture photographed personally, but the present invention may employ the composition that the customer's facial picture 15 is photographed using the television camera 12 provided at the optician's shop 7, the facial picture data is stored in recording medium such as a floppy disk or CD (compact disk), etc., and is provided with the customer as service, and the eyeglass frame 14 is synthesized with his/her own facial picture 15. In this case, since the customer's facial picture 15 is photographed using the television camera 12 provided at the optician's shop 7, the person does not need to perform to adjust the photographing magnification with respect to the eyeglass frame 14. Also, the facial picture may be transmitted to the personal computer at home or company, the portable telephone, PHS using the e-mail address.

In the embodiment of the present invention, the information on eyeglass frame database server 10 is provided at the optician's shop 7, however, the present invention may employ the composition that the information on eyeglass frame database server 10 is provided at the eyeglass frame manufacturing maker 13 and the information on eyeglass frame database server 10 of the eyeglass frame manufacturing maker 13 is linked to the home page which the optician 7 prepares, and thereby, the information on eyeglass frame is displayed on the monitor screen 2A.

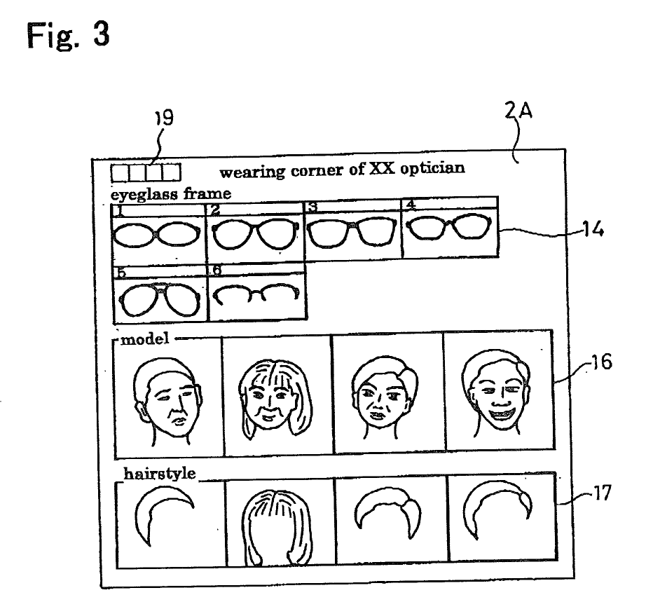

Also, in the present invention, the selected eyeglass frame 14 is worn to the person's facial picture 15, but, as shown in FIG. 3, the present invention may employ the composition that when the person accesses the home page of the optician 7 and selects the wearing corner of the eyeglass frame 14, a model's facial picture 16 and a hairstyle 17, etc. together with a plurality of eyeglass frames 14 are displayed on the monitor screen 2A, and the eyeglass frame 14, the model's facial picture 16 and the hairstyle 17 are selected and synthesized sequentially, and thereby, the facial picture of the selected eyeglass frame 14, the model's facial picture 16, and the hairstyle 17 are displayed on the monitor screen 2A. Also, when the background selection screen is formed and the background is selected, for example, the scene such as a skiing ground or a beach may be displayed on the screen 2A as the background of facial picture wearing the selected eyeglass frame.

In addition, in case where the suit is photographed in the facial picture photographed by the optician or personally, the suit color may be changed. Since the existing picture correcting software can be used therein, the skin color of face, the eyebrows style, the lip color, the cheek color, the hair color, wrinkles of brows, wrinkles of the end of eyes, and a bruise or freckles of face may be changed using the picture correcting software. Also, in case of the facial picture wearing the eyeglass, the eyeglass may be removed using the picture correcting software.

### Second Embodiment

In the first embodiment of the present invention, the picture synthesis is performed in the personal computer 1 side, but the present invention may employ the composition that the picture is synthesized in the server side of the optician 7 and the selected eyeglass frame 14 is synthesized with the facial picture to be displayed on the monitor screen 2A.

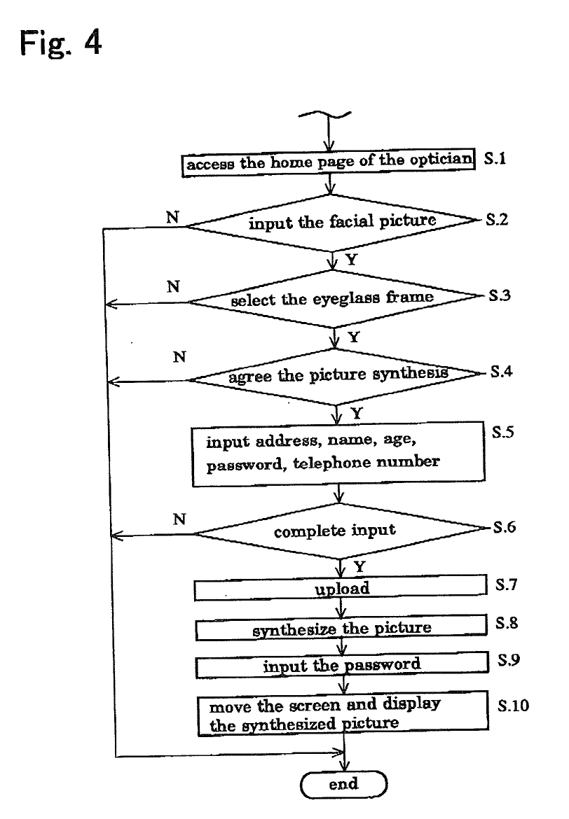

For example, as shown in FIG. 4, when the customer accesses the home page of the optician 7 through the personal computer 1 (S.1), the screen is moved to the facial picture inputting screen (S.2). When the facial picture is inputted, the screen is moved to the eyeglass frame selection screen (S.3). When the eyeglass frame 14 is selected on the eyeglass frame selection screen, the screen is moved to the picture synthesis agreeing screen (S.4), and identifier, such as address, name, age, telephone number and password are inputted (S.5). When the input is finished (S.6), the upload of the facial picture is performed (S.7).

In the optic 7, the selected eyeglass frame 14 is synthesized with the facial picture 15 according to the selected eyeglass frame 14 and the uploaded facial picture 15 at the web server 11 (S.8). And, when the password is inputted from the personal computer 1 side (S.9), the facial picture 15 wearing the selected eyeglass frame 14 is displayed on the monitor screen 2A.

According to the second embodiment of the present invention, when at least address and name are inputted and the picture synthesis is performed in the server of the optician 7 to display the synthesized picture on the monitor screen 2A, and thereby, the optician can surely grasp the preliminary customer group, and can systematically grasp the customer's favorite eyeglass frame. Also, it is convenient to save the customer trouble of synthesizing the picture.

As mentioned above, the embodiments according to the present invention are explained, but the composition which after the eyeglass frame is selected, the screen may be moved to the order screen to allow the customer to make an advance order the selected eyeglass frame at home may be provided.

Generally, since it is rare that the advance-ordered eyeglass frame is purchased as it is, if the advance order screen returns additionally to the eyeglass frame selection screen to select at least three eyeglass frames, the customer can try wearing a plurality of eyeglass frames actually when the customer visit the optician, and thereby, the time for receiving the customer can be shortened, and the satisfaction of the customer can be improved.

Also, in case where the advance-ordered eyeglass frame does not exist in the optician, the optician orders the advance-ordered eyeglass frame to a wholesale maker or a manufacturing maker. When the advance-ordered eyeglass frame is delivered to the optician from the wholesale maker or the manufacturing maker, the optician may notify the orderer through the e-mail that the eyeglass frame was delivered. Also, a hew frame may be notified through the e-mail.

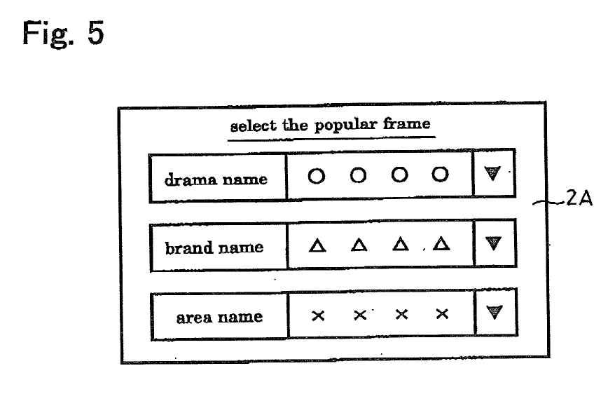

In addition, when the home page of the optician is accessed, the popular frame selection screen may be displayed on the monitor screen as shown in FIG. 5. When the drama name is selected, the eyeglass frame which the hero/heroine of the drama is wearing is displayed, when the brand name is selected, the popular eyeglass frame with the brand name is displayed, and when the area name is selected, the eyeglass frame which is popular in the area is displayed.

Further, the prescription data of eyeglass lens may be inputted through the keyboard 3 or the mouse 4, and the preemption data may be presumed from the prescription data stored in the customer managing database server 8. Also, the prescription data of eyeglass lens may be obtained from the database of an ophthalmologist 18 by lining the database of the optician 7 with that of the ophthalmologist 18 through the network.

According to the present Invention, since the eyeglass frame is selected at the home page by accessing the home page of the optician using the personal computer, it is convenient that the customer can judge what kind of eyeglass frame the customer purchases until the customer satisfies without visiting the optician personally and a clerk's help.

What is claimed is:

1. An eyeglass frame synthesizing system arranged for accessing through Internet using a web browser a home page created by an optician, selecting an eyeglass frame provided at said home page, synthesizing the selected eyeglass frame with a facial picture using a picture synthesizing program, and displaying a synthesized picture on a monitor screen.

2. An eyeglass frame synthesizing system according to claim 1, wherein the system makes a facial picture of a customer visiting said optician using a television camera and stores the facial picture in a recording medium, allowing the customer to select from said monitor screen an eyeglass frame provided at said home page and synthesizing said facial picture stored in said recording medium with said eyeglass frame.

3. An eyeglass frame synthesizing system according to claim 1, wherein a source of information on said eyeglass frame is stored in an eyeglass frame manufacturing maker, and said eyeglass frame can be selected by linking to said source through optician's shop.

4. An eyeglass frame synthesizing system according to claim 3, wherein the system transmits the facial picture to a personal computer, a portable telephone, or PHS by way of inputting an e-mail address at the optician's shop.

5. An eyeglass frame synthesizing system according to claim 1, wherein said facial picture is provided by a customer, and the picture synthesizing program has an operating means for adjusting a photographing magnification by specifying two points on said monitor screen and allowing the customer to input a distance between the two points in order to operate the magnification on the basis of the two points specified on the screen and the inputted distance between the two points.

6. An eyeglass frame synthesizing system according to claim 1, wherein the system displays a frame selection screen with a plurality of popular frames at said home page.

7. An eyeglass frame synthesizing system according to claim 1, wherein the system uploads a facial picture of a person accessing said home page for synthesizing the facial picture in optician's server and presenting a synthesized picture on said monitor screen.

8. An eyeglass frame synthesizing system according to claim 7, wherein upon an access of the home page by said person, the system gives an option to select a synthesis of the facial picture with an eyeglass frame, at the same time asking for permission to synthesize a picture in the optician's server, and, upon inputting at least an identifier and a password, the system uploads said facial picture in order to synthesize the picture in said server, and displays the synthesized picture on said monitor screen upon receiving authentication of said person by at least inputting of said password.

9. An eyeglass frame synthesizing system according to claim 7, wherein the system systematically grasps a favorite eyeglass frame selected by the customer after considering a personal information inputted when said eyeglass frame is selected and the selected eyeglass frame, for synthesizing the picture and displaying the synthesized picture on the monitor screen.

10. An eyeglass frame synthesizing system comprising a home page created by an optician and accessible through Internet using a web browser, a monitor screen for displaying an image in which a facial picture is synthesized with an eyeglass frame selected from an eyeglass frame selection screen, and a download means for downloading a picture synthesizing program for synthesizing said facial picture with the selected eyeglass frame and displaying the synthesized picture on said monitor screen on the basis of said home page.

11. An eyeglass frame synthesizing system according to claim 10, wherein the system makes a facial picture of a customer visiting said optician using a television camera and stores the facial picture in a recording medium, allowing the customer to select from said monitor screen an eyeglass frame provided at said home page in order to synthesize said facial picture from said recording medium with said eyeglass frame.

12. An eyeglass frame synthesizing system according to claim 10, further comprising a counter for counting a number of accesses to said home page.

13. An eyeglass frame synthesizing system according to claim 10, wherein a source of information on said eyeglass frame is stored in an eyeglass frame manufacturing maker, and said eyeglass frame can be selected by linking to said resource through optician's shop.

14. An eyeglass frame synthesizing system according to claim 10, wherein said facial picture is provided by a customer, and the picture synthesizing program has an operating means for adjusting a photographing magnification by specifying two points on said monitor screen and allowing the customer to input a distance between the two points in order to operate the magnification on the basis of the two points specified on the screen and the inputted distance between the two points.

15. An eyeglass frame synthesizing system according to claim 11, wherein the system transmits the facial picture to a personal computer, a portable telephone, or PHS by way of inputting the e-mail address at the optician's shop.

16. An eyeglass frame synthesizing system comprising a home page created by an optician and accessible through Internet using a web browser, a monitor screen for displaying an image in which a facial picture is synthesized with an eyeglass frame selected from an eyeglass frame selection screen, and a upload means for uploading a picture synthesizing program for synthesizing said facial picture with the selected eyeglass frame and displaying the synthesized picture on said monitor screen on the basis of said home page.

17. An eyeglass frame synthesizing system according to claim 16, wherein upon an access of the home page by said person, the system gives an option to select a synthesis of the facial picture with an eyeglass frame, at the same time asking for permission to synthesize a picture in the optician's server, and, upon inputting at least an identifier and a password, the system uploads said facial picture in order to synthesize the picture in said server, and displays the synthesized picture on said monitor screen upon receiving authentication of said person by at least inputting of said password.

18. An eyeglass frame synthesizing system according to claim 16, wherein the system systematically grasps a favorite eyeglass frame selected by the customer after considering a personal information inputted when said eyeglass frame is selected and the selected eyeglass frame, for synthesizing the picture and displaying the synthesized picture on the monitor screen.

19. An eyeglass frame synthesizing system according to claim 16, further comprising a counter for counting a number of accesses to the home page.

20. A method for selling eyeglasses by creating a system having a database for storing data on eyeglass lens and eyeglass frames necessary for making eyeglasses for a customer visiting an optician, a database for storing a facial picture of the customer, a database for storing an information on eyeglass frames of various kinds, a web server for presenting a home page of the optician on a monitor screen of a personal computer, and a picture synthesizing program for synthesizing the eyeglass frame with the facial picture and displaying a synthesized picture, the method including the steps of:
selecting an eyeglass frame on said home page;
uploading or downloading said picture synthesizing program to display the synthesized picture on the monitor screen; and
selling eyeglasses with selected eyeglass frame off the monitor screen according to an order posted by the customer.
